(19) United States
(12) Patent Application Publication
(10) Pub. No.: US 2025/0038825 A1
(43) Pub. Date: Jan. 30, 2025

(54) DEFINING A TIMELINE FOR FAST UPLINK BEAM AND/OR PANEL SELECTION

(71) Applicant: Nokia Technologies Oy, Espoo (FI)

(72) Inventors: Sami-Jukka HAKOLA, Kempele (FI); Juha Pekka KARJALAINEN, Sotkamo (FI); Mihai ENESCU, Espoo (FI)

(73) Assignee: Nokia Technologies Oy, Espoo (FI)

(21) Appl. No.: 18/709,047

(22) PCT Filed: Jul. 28, 2022
(86) PCT No.: PCT/EP2022/071150

§ 371 Date: May 10, 2024

(30) Foreign Application Priority Data
Nov. 12, 2021 (FI) 20216169

(51) Int. Cl. H04B 7/06

(52) U.S. Cl. CPC H04B 7/06968; H04B 7/06964

(57) ABSTRACT

According to an aspect, there is provided an apparatus. The apparatus causes transmitting, by a terminal device, a first message comprising a capability value set index and a synchronization signal block resource index, SSBRI, or a channel state information reference signal resource index, CRI. The capability value set index is associated with a sounding reference signal, SRS, resource set. The apparatus causes the terminal device to receive a second message defining a transmission configuration indication, TCI, state comprising a quasi co-location, QCL, -TypeD reference signal corresponding to the SSBRI or CRI or being quasi co-located in terms of QCL-TypeD with a reference signal corresponding to the SSBRI or CRI. The apparatus causes the terminal device to active or indicate the TCI state. If the SRS resource set is different from an active SRS resource set, the apparatus applies a pre-defined latency time between application and expected triggering of the SRS resource set.

### TECHNICAL FIELD

The various example embodiments relate to communications.

### BACKGROUND

The fifth generation cellular systems (5G) and beyond aim to improve the throughput by a huge factor (even up to 1000 or more), which provides a multitude of challenges, especially considering the scarcity of spectrum at low frequency bands and the need for supporting a very diverse set of use cases. In order to reach this goal, it is important to exploit the higher frequencies such as millimeter wave frequencies in addition to the more conventional lower frequencies. However, the connection between an access node (e.g., a gNodeB, gNB) and a terminal device at millimeter waves is highly sensitive to any kind of blockages due to the use of narrow beams and poor penetration capability of signals with high (carrier) frequency. Multiple beam pair links may be configured and updated between the access node and the terminal device to adapt to the movement of the terminal device and/or changes in the radio environment (e.g., sudden blockage caused by a moving obstruction such as a truck) within a cell and thus to improve reliability of millimeter wave connections.

One future development involves facilitation of fast beam/panel selection for the uplink transmission of the terminal device which needs to transmit and receive using antenna panels (i.e., antenna arrays) with different capabilities. Such different capabilities may comprise, e.g., different number of antenna ports, different number of beams, different achievable effective isotropic radiated power (EIRP) and/or transmission (Tx) power, and/or switch on and switch off times. However, multiple open questions still remain regarding the implementation of said functionality.

### BRIEF DESCRIPTION

According to an aspect, there is provided the subject matter of the independent claims. Embodiments are defined in the dependent claims.

According to an aspect, there is provided an apparatus comprising:
at least one processor; and
at least one memory including computer program code;
the at least one memory and the computer program code configured to, with the at least one processor, cause the apparatus at least to perform:
causing a terminal device to transmit a first message comprising a capability value set index and at least one of a synchronization signal block resource index, SSBRI, or a channel state information reference signal resource index, CRI, wherein the capability value set index is associated with a sounding reference signal, SRS, resource set configured to the terminal device; and
in response to receiving a transmission configuration indication, TCI, state update message for the SRS resource set, causing the terminal device to update a TCI state for the SRS resource set according to the TCI state update message.

According to an aspect, there is provided an apparatus comprising:
at least one processor; and
at least one memory including computer program code;
the at least one memory and the computer program code configured to, with the at least one processor, cause the apparatus at least to perform:
receiving, by an access node, a first message comprising a capability value set index and at least one of a synchronization signal block resource index, SSBRI, and a channel state information reference signal resource index, CRI, wherein the capability value set index is associated with a sounding reference signal, SRS, resource set configured to the terminal device; and
in response to the capability value set index failing to match a last reported capability value set index, causing the access node to transmit a TCI state update message for the SRS resource set.

According to an aspect, there is provided a method comprising:
transmitting a first message comprising a capability value set index and at least one of a synchronization signal block resource index, SSBRI, or a channel state information reference signal resource index, CRI, wherein the capability value set index is associated with a sounding reference signal, SRS, resource set; and
in response to receiving a TCI state update message for the SRS resource set, updating of a TCI state for the SRS resource set according to the TCI state update message.

According to an aspect, there is provided a method comprising:
receiving a first message comprising a capability value set index and at least one of a synchronization signal block resource index, SSBRI, and a channel state information reference signal resource index, CRI, wherein the capability value set index is associated with a sounding reference signal, SRS, resource set; and
in response to the capability value set index failing to match a last reported capability value set index, transmitting a TCI state update message for the SRS resource set.

According to an aspect, there is provided a computer program product, embodied on a non-transitory computer readable medium, comprising program instructions, that when run is adapted to perform:
causing receiving, by an access node, a first message comprising a capability value set index and at least one of a synchronization signal block re-source index, SSBRI, and a channel state information reference signal resource index, CRI, wherein the capability value set index is associated with a sounding reference signal, SRS, resource set configured to the terminal device; and
in response to the capability value set index failing to match a last reported capability value set index last reported, causing transmitting, by the access node, a second message defining a transmission configuration indication, TCI, state comprising a quasi co-location, QCL, -TypeD reference signal corre-sponding to one of the at least one of the SSBRI and the CRI or is quasi co-located in terms of QCL-TypeD with a reference signal corresponding to one of the at least one of the SSBRI and the CRI.

According to an aspect, there is provided a computer program product, embodied on a non-transitory computer readable medium, comprising program instructions, that when run is adapted to perform:
causing a terminal device to transmit a first message comprising a capability value set index and at least one of a synchronization signal block resource index, SSBRI, or a channel state information reference signal resource index, CRI, wherein the capability value set index is associated with a sounding reference signal, SRS, resource set configured to the terminal device; and
in response to receiving a transmission configuration indication, TCI, state update message for the SRS resource set, causing the terminal device to update a TCI state for the SRS resource set according to the TCI state update message.

According to an aspect, there is provided a computer program product, embodied on a non-transitory computer readable medium, comprising program instructions, that when run is adapted to perform:
causing an access node to receive a first message comprising a capability value set index and at least one of a synchronization signal block resource index, SSBRI, or a channel state information reference signal resource index, CRI, wherein the capability value set index is associated with a sounding reference signal, SRS, resource set; and
in response to the capability value set index failing to match a last reported capability value set index, causing the access node to transmit a TCI state update message for the SRS resource set.

One or more examples of implementations are set forth in more detail in the accompanying drawings and the description below. Other features will be apparent from the description and drawings, and from the claims.

### BRIEF DESCRIPTION OF DRAWINGS

In the following, exemplary embodiments will be described with reference to the attached drawings, in which

FIG. 1 illustrates a wireless communication scenario to which embodiments may be applied;

FIGS. 2 and 3 illustrate processes according to embodiments; and

FIGS. 4 and 5 illustrate apparatuses according to embodiments.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The expression “communicatively connected” as used in the following may have the meaning of connected so as to enable communication (i.e., transmission and/or reception of signals) between the connected elements. Elements which are communicatively connected may be connected, for example, via one or more wired communication links, one or more wireless communication links, one or more wired communication networks and/or one or more wireless communication networks. The expression “communicatively connected” does not necessarily imply that the associated elements are electrically connected (i.e., connected via a conducting path) and/or physically connected.

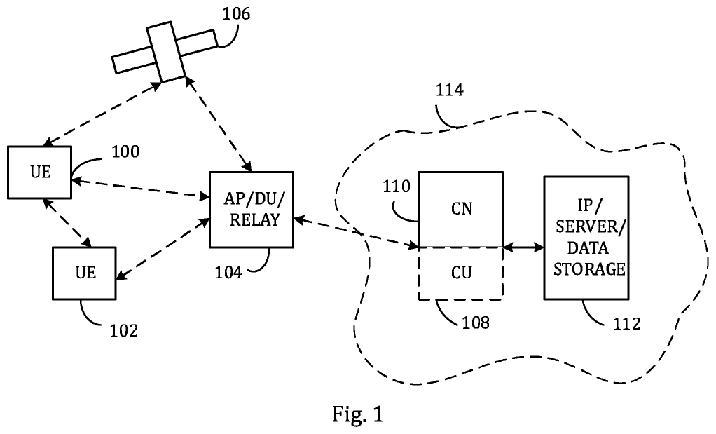

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. As an example of the relay station, the gNB functionalities may be carried out by DU part of the IAB (integrated access and backhaul) node. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a so-called IAB node, where UE functionalities are carried out by MT (Mobile Termination) part of the IAB node. The MT part may be called also as IAB-UE.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device (or in some embodiments a relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT (Radio Access Technology) operability (such as LTE-5G) and inter-RI operability (inter-radio interface operability, such as below 6 GHz—cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and man-aged. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of access nodes such as (e/g)NodeBs, the user device may have an access to a plurality of radio cells and the system may comprise also other apparatuses, such as relay (or IAB) nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically in-stalled within an operator's network may aggregate traffic from a large number of HNBs back to a core network.

Beam Management defines a set of functionalities to assist terminal device to set its reception (Rx) and transmission (Tx) beams for downlink receptions and uplink transmissions, respectively. The functionalities can be categorized roughly according to four groups:

### 1. Beam Indication

Assist terminal device to set its Rx and Tx beam properly for the downlink reception and uplink transmission, respectively.

### 2. Beam Acquisition, Measurements and Reporting

Procedures for providing access node knowledge about feasible downlink and uplink beams for the terminal device.

### 3. Beam Recovery

For rapid link reconfiguration against sudden blockages, i.e. fast re-alignment of the access node and terminal device beams

### 4. Beam Tracking and Refinement

Set of procedures to refine access node and terminal device side beams Regarding downlink beam management and especially for Beam Acquisition, Measurements and Reporting, the following beam management procedures may be supported within one or multiple transmission/reception points (TRPs) of the serving cell.
P-1 procedure is used to enable terminal device measurement on different TRP Tx beams to support selection of TRP Tx beams/terminal device Rx beam(s). For beamforming at TRP, it typically includes an intra/inter-TRP Tx beam sweep from a set of different beams. For beamforming at terminal device, it typically includes a terminal device Rx beam sweep from a set of different beams.
P-2 procedure is used to enable terminal device measurements on different TRP Tx beams to possibly change inter/intra-TRP Tx beam(s). P-2 may involve possibly smaller set of beams for beam refinement compared to P-1. Note that P-2 can be a special case of P-1.
P-3 procedure is used to enable terminal device measurements on the same TRP Tx beam to change terminal device Rx beam in the case where the terminal device uses beamforming.

Regarding downlink beam indication, a quasi-colocation (QCL) indication functionality has been defined. Quasi co-location may be defined so that two antenna ports are said to be quasi co-located if some properties of the channel over which a symbol on one antenna port is conveyed can be inferred from the channel over which a symbol on the other antenna port is conveyed. An antenna port is, here, a logical concept defined such that the channel over which a symbol on the antenna port is conveyed can be inferred from the channel over which another symbol on the same antenna port is conveyed. Each antenna port corresponds to a specific (characteristic) channel (i.e., symbols transmitted over a given antenna port are subject to the same propagation conditions) and is associated with its own reference signal. There is one resource grid per antenna port.

In other words, each transmitted reference signal is subject to specific (characteristic) propagation conditions between a transmitter and a receiver and reference signals that are sharing the same or similar propagation conditions are considered quasi collocated. Each reference signal may have (or be associated with) a source reference signal. However, for example, SSB (Synchronization Signal Block referring more specifically to a Synchronization/Physical Broadcast Channel block) does not have a source reference signal.

The principle for receiving a certain physical signal or physical channel using the QCL indication functionality may be defined as follows. The terminal device is either configured with or implicitly determines a source reference signal that terminal device has received and measured earlier which defines how to set Rx beam for the reception of the downlink (target) physical signal or channel to be received. To provide terminal device with QCL characteristics for the target signal (to be received), a transmission coordination indication (TCI) framework has been defined using which the terminal device can be configured with one or more TCI states. The one or more TCI states define for the terminal device one or more source reference signals for determining QCL characteristics. Specifically, each TCI state comprises one or two source reference signals which provide the terminal device QCL parameters of one or two (or more than two) particular QCL types.

Four different QCL types, between two reference signals or a reference signal and a channel (including physical data and control channels), may be defined. These four QCL types are defined as shown in the table below.

| QCL Type | QCL parameter set |
|---|---|
| QCL-TypeA | Doppler shift, Doppler spread, |
| | average delay, delay spread |
| QCL-TypeB | Doppler shift, Doppler spread |
| QCL-TypeC | average delay, Doppler shift |
| QCL-TypeD | spatial Rx parameter (for beamforming) |

To give an example, a PDCCH (i.e., a channel) from an access node and an SSB (i.e., a reference signal) are quasi collocated if it is determined that they both encounter similar channel conditions (or properties). The sameness of the channel conditions in view of a particular QCL Type is evaluated by looking at the QCL parameter sets as defined on the table above. For example, quasi co-location of in view of QCL-TypeC means that similar average delay and Doppler shift is encountered. When two reference signals or channels are of the same QCL-TypeD, it is assumed that the same analog beam-pair is utilized for both reception and transmission.

A Transmission Configuration Indicator (TCI) states are state configurations within the higher layer parameter PDSCHConfig. Each TCI state contains parameters for configuring a quasi co-location relationship between one or two downlink reference signals and the DMRS (demodulation reference signal) ports of the physical downlink shared channel (PDSCH), the DMRS port of PDCCH or the CSI-RS port(s) of a CSI-RS resource. TCI states may be dynamically sent over in a DCI (Downlink Control Information) message which includes configurations such as QCL-relationships between the downlink RSs in one CSI-RS (Channel State Information Reference Signal) set and the PDSCH DMRS (Physical Downlink Shared CHannel DeModulation Reference Signal) ports. A terminal device may be configured with a list of up to M TCI states to decode a PDSCH according to a detected Physical Downlink Control CHannel (PDCCH) with DCI intended for the terminal device and a given serving cell. Here, M is an integer which depends on the terminal device capability (e.g. on maxNumberActiveTCI-PerBWP).

In uplink beam indication, a terminal device may be provided (by an access node) a parameter called spatial relation info which defines a spatial source reference signal based on which the terminal device is capable of determining the uplink transmit beam. The spatial source reference signal may be a downlink reference signal (e.g., an SSB or a CSI-RS) or an uplink reference signal (e.g., a sounding reference signal, SRS). For each physical uplink control channel (PUCCH) and SRS resource, the access node may explicitly provide a spatial source while for physical uplink shared channel (PUSCH) indirect indication may be provided. If PUSCH is scheduled using DCI format 0_0, spatial source may be the same as with a certain (pre-defined) PUCCH resource. If PUSCH is scheduled using DCI format 0_1, the spatial source may be the same as one or more indicated SRS resources such as one SRS resource indicated in a codebook based transmission scheme or one or more SRS resources indicated in a non-codebook based transmission scheme.

A default spatial relation for dedicated PUCCH/SRS (except SRS with usage=‘beamManagement’ and SRS with usage=‘nonCodeBook’ and configured with associated CSI-RS) may be defined. Here, if spatial relation is not configured in FR2 frequency range, the terminal device determines spatial source as:
In case when one or more control resource sets (CORESETs) are configured on the component carrier (CC), the default spatial relation is TCI state/QCL assumption of the CORESET with the lowest ID and/or
In case when any CORESETs are not configured on the CC, the activated TCI state with the lowest ID is applicable to PDSCH in the active DL-BWP of the CC.

A CORESET may be defined as a set of physical resources (i.e., a specific area on NR Downlink Resource Grid) and a set of parameters that is used to carry the PDCCH and DCI. Specifically, a CORESET may be defined as a resource allocation unit made up of resource element groups (REGs) in frequency domain and 1 or 2 or 3 OFDM symbols in time domain. Each REG may be made of a resource block (RB) comprising 12 re-source elements (RE). Each of the one or more CORESETs may comprise a single TCI state or multiple TCI states. Only one TCI state is active at a given time for a given CORESET. An access node may switch the active TCI state of the terminal device by a transmitting MAC-CE (Medium Access Control—Control Element) command to the terminal device.

Furthermore, a default spatial relation for PUSCH scheduled by DCI format 0_0 may be defined. Here, the terminal device may determine spatial relation as follows:
when there is no PUCCH resources configured on the active uplink BWP CC:
   The default spatial relation is the TCI state/QCL assumption of the CORESET with the lowest ID.
   The default pathloss RS is the QCL-TypeD RS of the same TCI state/QCL assumption of the CORESET with the lowest ID.
when there is no PUCCH resources configured on the active UL BWP CC in FR2 and in radio resource control (RRC)-connected mode:
   The default spatial relation is the TCI state/QCL assumption of the CORESET with the lowest ID.
   The default pathloss RS is the QCL-TypeD RS of the same TCI state/QCL assumption of the CORESET with the lowest ID.

In some communication systems to which embodiments may be applied, a unified TCI framework may be established meaning that TCI states providing (previously) QCL assumptions for the reception of downlink signals and channels may be used also to provide spatial sources for the transmission of UL signals and channels. Furthermore, the unified TCI framework defines the concept of indicated TCI state. The indicated TCI state can be joint downlink and uplink TCI state or separate downlink and separate uplink TCI states. Indicated TCI state provides QCL source (DL) and spatial source (UL) for the set of downlink signals and channels and for the set of uplink signals and channels, respectively. One or more indicated joint downlink and uplink TCI states and/or one or more indicated downlink TCI states and one or more indicated uplink TCI states may be defined for a given terminal device according to the unified TCI framework.

On the unified TCI framework, the following aspects may be defined:
Common TCI state (equally called indicated TCI) for a set of signals and channels at a time.
TCI state can be a joint downlink/uplink state, a separate downlink TCI state and separate uplink TCI state.
RRC is capable of configuring a set (or a pool) of joint and/or separate TCI states.
MAC activates a number (e.g. 8) of joint and/or separate TCI states.
Before first indication, first activated TCI state is the current indicated TCI state.
DCI indicates one of the activated TCI states to be indicated TCI state (which may be a common TCI state).

Regarding the DCI-based TCI state indications, the following may apply:
DCI format 1_1 or 1_2 with and without downlink assignment may be used to carry the TCI state indication.
Indication may be confirmed by hybrid automatic repeat request (HARQ) acknowledgment (ACK) by the terminal device.
Application time of the beam indication: the first slot that is at least X ms or Y symbols after the last symbol of the acknowledgment of the joint or separate downlink/uplink beam indication
TCI field codepoint:
A joint TCI state for both downlink and uplink.
Separate TCI states for downlink and uplink.

At least some of the embodiments to be discussed below may specifically be targeting enabling of fast beam/panel selection for the uplink transmission of a terminal device which comprises multiple (transmit and/or receive) panels (i.e., antenna arrays) with different capabilities. Different capabilities among the panels (or antenna arrays) may comprise, for example, one or more of:
different number of antenna ports,
different number of beams,
different achievable effective isotropic radiated power (EIRP) and/or Tx power and
switch on and switch off times.
   These capabilities (or at least some of them) for a given panel of the terminal device may be defined in a capability value set. A terminal device comprising multiple panels may be called a multi-panel terminal device.

Once such a multi-panel terminal device has provided three capability value sets for an access node, it may subsequently be configured with three respective SRS resource sets. The three SRS resource set correspond to the three capability value sets, e.g., in terms of number of SRS antenna ports and/or number of SRS resources in the set. Furthermore, the access node may have configured the terminal device so that the SRS resource sets correspond to indicated uplink TCI states. After receiving the associated report from the terminal device, the access node may update (e.g., activate and/or indicate) the TCI state and trigger an aperiodic SRS resource set or activate a semi-persistent SRS resource set of which configuration corresponds to the capability value/values of the reported capability value set index.

However, a timeline for the triggering of the (aperiodic) SRS resource set after the terminal device has provided the report to the access node is not known to the terminal device. In other words, the terminal device is not aware when the triggering of the SRS resource set is to be expected. This triggering time instance may depend at least on whether or not the SRS resource set to be triggered corresponds to the currently activated or last used SRS resource set of the terminal device.

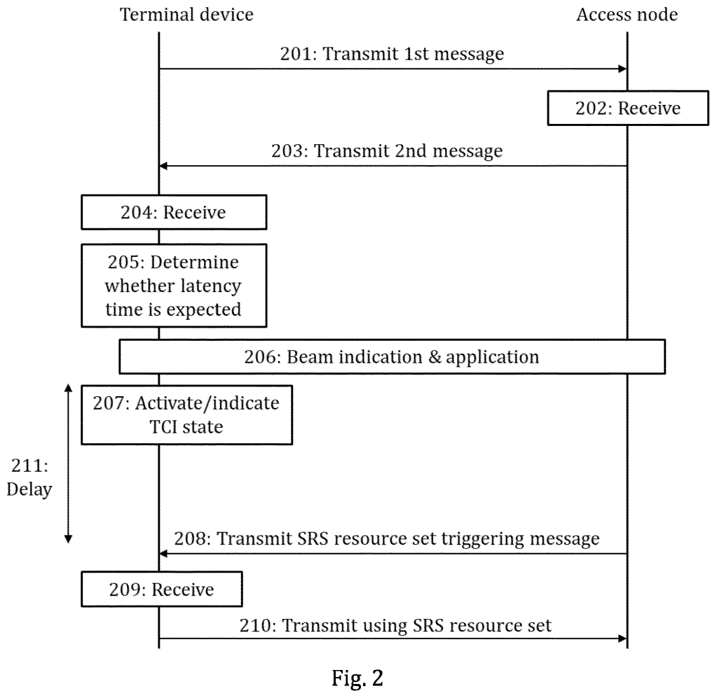

FIG. 2 illustrates signaling according to embodiments for defining a timeline for the triggering of an SRS resource set after the terminal device has provided a report regarding said SRS resource set. Specifically, FIG. 2 shows signaling between a terminal device and an access node (serving said terminal device). The illustrated terminal device may be, e.g., either of the terminal devices 100, 102 of FIG. 1. The illustrated access node may be, e.g., the access node 104 of FIG. 1. The terminal device may be a multi-panel terminal device. The actions shown in FIG. 2 as being performed by the terminal device and the access node may be caused or triggered to be performed by an apparatus (e.g., a computing device) comprised in or communicatively connected to the terminal device and the access node, respectively.

Referring to FIG. 2, one or more of the following assumptions and definitions given below before discussion on block 201 may apply initially for the terminal device of FIG. 2.

The terminal device may support one or more capability value sets. The terminal device may maintain, in at least one memory, information on the one or more capability value sets and one or more capability value set indices associated, respectively, with the one or more capability value sets. A capability value set comprises information on capabilities of a panel of a (multi-panel) terminal device. Each capability value set of the terminal device may comprise information on the (maximum supported) number of (SRS) antenna ports, number of beams, EIRP, coherence type among the ports (full, partial, no coherence) and/or maximum number of uplink layers. In some embodiments, each capability value set of the terminal device may comprise at least information on the maximum supported number of (SRS) antenna ports. Each capability value set may be associated with a particular capability value set index (equally called a capability set index or an index of a capability value set).

The terminal device may be (pre)configured with one or more SRS resource sets. The terminal device may maintain, in at least one memory, information on the one or more SRS resource sets (and associated SRS resource set indices). An SRS resource set may be defined as a set of SRS resources having same power control information. An SRS resource may correspond to a set of one or more SRS ports, each of which may correspond to an actual physical antenna of the terminal device or a virtual antenna constructed by an analog, digital, or hybrid precoding operation of the physical antennas of the terminal device. Each SRS resource set may be associated with a particular SRS resource set index.

In some embodiments, some of the one or more SRS resource sets configured to the terminal device may be configured to follow indicated TCI states while the others may be configured explicitly with the TCI states for determining an uplink spatial filter (and thus a beam) for the transmission. Specifically, a QCL-TypeD reference signal included in a TCI state (for uplink transmission) may be used for determining the uplink spatial filter (beam) for the transmission by the terminal device.

The terminal device may be (pre)configured with joint downlink/uplink TCI states or with separate downlink and uplink TCI states. The terminal device may maintain, in at least one memory, information on the configured joint downlink/uplink TCI states and/or separate downlink and uplink TCI states. For example, up to 8 TCI states/codepoints may be activated, where some or all of the codepoints include an uplink TCI state.

For the measurements and reporting, the terminal device may be (pre)configured with a set (or a pool) of one or more SSBs and/or a set (or a pool) of one or more CSI-RSs. Each SSB may be associated with an SSB resource index (SSBRI) and/or each CSI-RS may be associated with a CSI-RS resource index (CRI). The terminal device may maintain, in at least one memory, information on the set of one or more SSBs and/or the set of one or more CSI-RSs and/or associated SSBRIs and/or CRIs.

The process of FIG. 2 initiated when the terminal device transmits, in message 201, a first message to the access node. The first message comprises a capability value set index and at least one of SSBRI or a CRI (or more generally one or more SSBRIs and/or one or more CRIs). Here, the capability value set index is associated with an SRS resource set configured to the terminal device. The first message may be equally called a (first) report. The capability value set index may represent a particular panel of the terminal device usable for measuring the reported resource index (i.e., the SSBRI or CRI) and/or considered to be the panel used for the uplink transmission based on the reported resource index. The SRS resource set may be an aperiodic or a semi-persistent SRS resource set. The terminal device may maintain, in at least one memory, the capability value set index, the capability value set associated with the capability value set index, the SSBRI, the CRI and/or SRS resource set.

In some embodiments, the terminal device may be configured to report, in message 201, N SSBRI(s) and/or N CRI(s) together with the capability value set index, where N is 1, 2, 3, 4, . . . or 16. The N SSBRI(s) and/or N CRI(s) may correspond to N best measured SSBRI(s) and/or CRI(s) (i.e., N best measured SSBs and/or N best measured CSI-RSs).

The first message is received, in block 202, by the access node. Upon reception of the first message, the access node determines, also in block 202, whether the capability value set index matches a capability value set index last reported by the terminal device. The last reported capability value set index may be maintained, e.g., in a memory of the access node. In response to the capability value set index failing to match a capability value set index last reported by the terminal device in block 202, the access node transmits, in message 203, a second message, defining a TCI state comprising a QCL-TypeD reference signal corresponding to one of the at least one of the SSBRI and the CRI or a QCL-TypeD reference signal which is quasi co-located in terms of QCL-TypeD with a reference signal corresponding to one of the at least one of the SSBRI and the CRI. In the latter case, the terminal device is able to receive both reference signals using the same Rx beam. In other words, the reference signals are in the same QCL chain where one can be a source reference signal to the other.

The second message may be transmitted by the access node in response to determining, also in block 202, that the capability value set index fails to match a last reported capability value set index (i.e., the capability value set index last reported by the terminal device). The last reported capability value set index may be maintained, e.g., in a memory of the access node.

The second message may be a TCI state activation message (being a MAC-CE-based message) or a TCI state indication message (being a DCI-based message). Any of the definitions provided above for the MAC-CE-based TCI state activation messages and/or the DCI-based TCI state indication messages may apply here.

If the SSB or CSI-RS specified in the first message (by the SSBRI/CRI, respectively) is not comprised (yet) in any activated TCI state of the terminal device but is included in one of the configured TCI states of the terminal device, the access node may activate the TCI state and the corresponding timeline may be adopted (MAC-CE based TCI state switch/activation). Thus, the second message 203 may, in this case, be a TCI activation message for activating one of the currently configured (but non-activated) TCI states of the terminal device.

If the terminal device is preconfigured with one or more joint downlink/uplink TCI states or one or more pairs of separate downlink and uplink TCI states (as described above) and further if the SSB or CSI-RS specified in the first message (by the SSBRI/CRI, respectively) is not comprised in the currently indicated joint uplink/downlink or uplink TCI state of the terminal device but is comprised in one of the activated TCI states of the terminal device (which may comprise one or more joint uplink/downlink TCI states and/or one or more uplink TCI states), the access node may indicate the TCI state for the terminal device and the corresponding timeline may be adopted (Rel17 DCI based TCI state indication). In other words, the second message 203 may, in this case, be a TCI indication message for indicating one of the currently activated TCI states.

It should be noted that if the first message indicates the same SSBRI or CRI as reported earlier but different capability value set index, the access node may still need to perform the TCI state indication (i.e., transmit the second message 203) even though the TCI state itself would be the same in order to be able to trigger the SRS resource set associated with the latest reported capability value set index.

The terminal device receives, in block 204, the second message as defined above. Based on reception of the second message in block 204, the terminal device knows that the next SRS resource set which is triggerable by the access node is the one that is associated with the same capability value set index that the terminal device provided in the first message along with the reference signal index (i.e., SSBRI or CRI).

The terminal device determines, in block 205, whether a pre-define latency time is to be applied. Namely, if the SRS resource set (associated with capability re-source set index) is different from a currently activated SRS resource set of the terminal device or an SRS resource set last used for transmission by the terminal device (as is assumed in FIG. 2), the terminal device determines, in block 205, that a pre-defined latency time 211 is to be applied between beam indication and related (subsequent) beam application time and an expected triggering time of the SRS resource set (or equally between the beam application and the expected triggering time of the SRS resource set), as illustrated with elements 206 to 209, 211. The beam indication and related beam application time (i.e., the starting time for the pre-defined latency time) may correspond to a time instance when the beam indication and related beam application process has been completed (i.e., to an end of the beam application time corresponding to a time when a TCI state activation/indication is initiated). The pre-defined latency time is applied so that the terminal device is able to activate the SRS resource set and to get ready for the transmission with the SRS resource set. The expected triggering of the SRS resource set may correspond to a time instance when the terminal device expects, at the earliest, to receive an SRS resource triggering message (message 208) from the access node. The pre-defined latency time may depend on the capability value set index included in the first message. The pre-defined latency time may be equal to or larger than 0 seconds.

More specifically, beam indication and subsequent beam application may be performed between the terminal device and the access node in block 206. The beam indication may comprise here assisting, by the access node, the terminal device to set its uplink transmission beam. The beam indication may be based on Rel-17 unified TCI framework. The beam indication may be performed as described above for uplink beam indication. The beam application may comprise configuring the terminal device to use the uplink beam selected using the beam indication process.

The beam indication and application in block 206 may be carried out by performing at least the following. First, the access node transmits DCI on PDCCH to the terminal device. The DCI comprises TCI defining the new TCI state to be indicated after a beam application time. Upon reception of the DCI, the terminal device transmits a HARQ ACK to the access node (for confirming the indication). Then, there is a pre-defined/configured beam application time which is counted from the end of the uplink transmission of the HARQ-ACK. The terminal device determines the slot when the new indicated TCI state is applied (or is in effect) by monitoring when the time which has passed since the end of the uplink transmission carrying the HARQ-ACK exceeds the pre-defined/configured beam application time.

The terminal device updates (or specifically activates and/or indicates), in block 207, the TCI state (of the terminal device) according to the second message (and following the pre-defined/configured beam application time). The updating (or the activating/indicting) may occur in the boundary of the determined slot. Specifically, if the second message 203 is the TCI state activation message, the terminal device may activate, in block 207, the TCI state being a currently non-active TCI state configured to the terminal device and, if the second message 203 is the TCI state indication message, the terminal device may indicate, in block 207, the TCI state being a joint downlink/uplink TCI state configured to the terminal device or a separate uplink TCI state configured to the terminal device.

Following the beam indication and application in block 206, the pre-defined latency time 211 is applied at the terminal device between the end of the beam indication and application 206 (e.g., the end of the beam application time) and (expected) transmission of the SRS resource set triggering message 208 (in this example, it is assumed that the SRS resource set is different from a currently activated SRS resource set of the terminal device or an SRS resource set last used for transmission by the terminal device).

After the pre-defined latency time has passed, the access node transmits, in message 208, a third message for triggering the SRS resource set to the terminal device. In response to receiving the third message in block 209, the terminal device transmits, in message 210, one or more SRSs using the SRS resource set.

If the SRS resource set (associated with capability resource set index) is the same as the currently activated SRS resource set of the terminal device or the SRS resource set last used for transmission by the terminal device, the terminal device determines, in block 205, that the pre-defined latency time 211 is not be applied between beam application and expected triggering of the SRS resource set. This alternative is not shown in FIG. 2.

In some embodiments, in response to detecting a beam failure recovery or a link re-establishment, a terminal device may set an SRS resource set with lowest capabilities (e.g. in terms of the number of SRS antenna ports) or lowest identifier as an active SRS resource set of the terminal device. This may be relevant for in view of the determination in block 205.

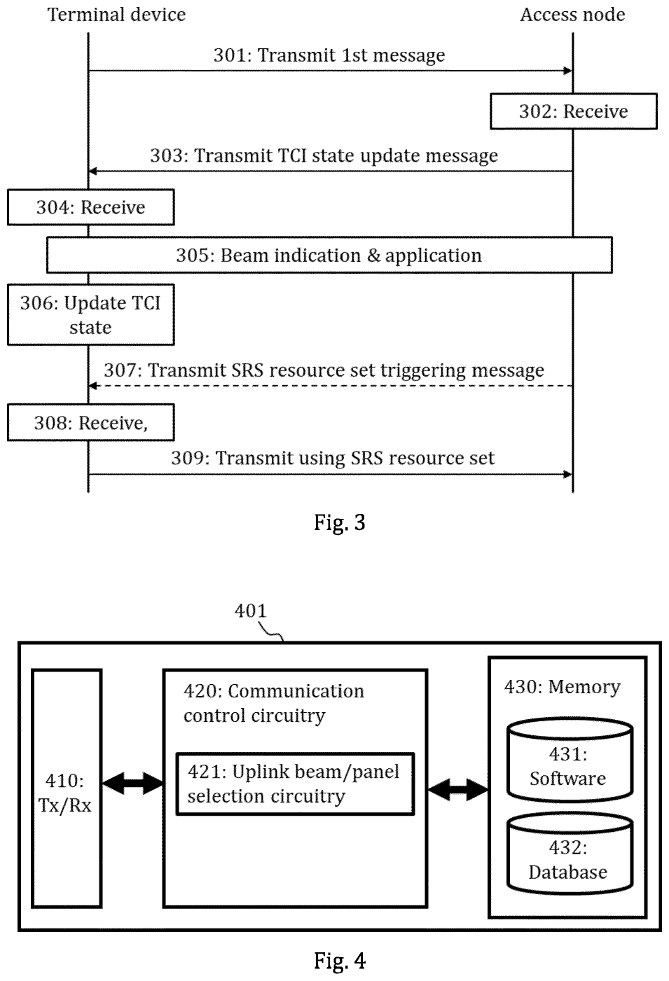

FIG. 3 illustrates alternative signaling according to embodiments for defining a timeline for the triggering of an SRS resource set after the terminal device has provided a report regarding the SRS resource set. Specifically, FIG. 3 shows signaling between a terminal device and an access node (serving the terminal device). The illustrated terminal device may be, e.g., either of the terminal devices 100, 102 of FIG. 1. The illustrated access node may be, e.g., the access node 104 of FIG. 1. The terminal device may be a multi-panel terminal device. The actions shown in FIG. 3 as being performed by the terminal device and the access node may be caused or triggered to be performed by an apparatus (e.g., a computing device) comprised in or communicatively connected to the terminal device and the access node, respectively.

Any of the initial assumptions and definitions listed in connection with FIG. 2 may apply, mutatis mutandis, for the terminal device of FIG. 3.

The actions pertaining to elements 301, 302 may correspond fully to actions discussed in connection with elements 201, 202 of FIG. 2, respectively, and are thus discussed here (again) for brevity.

The procedure of FIG. 3 differs from the procedure of FIG. 2 in that, following the reception of the first message in block 202, the access node transmits, in message 303, a TCI state update message for the SRS resource set associated with the first message or specifically associated with the capability value set index defined in the first message. Thus, no second message as defined in connection with element 203 of FIG. 2 is transmitted. The TCI state update message may be a MAC-CE message (i.e., a MAC-CE based TCI state update message). The transmitting in message 303 may be triggered in response to determining, by the access node, that the capability value set index failing to match a last reported capability value set index (i.e., a capability value set index last reported by the terminal device to the access node), similar to as discussed in connection with the second message 203 of FIG. 2.

In response to receiving in block 304, the TCI state update message for the SRS resource set, the terminal device updates, in block 306, the TCI state for the SRS resource set according to the TCI state update message. In this embodiment, the terminal device assumes a TCI state update message will be received before the SRS resource set will be triggered. Thus, no pre-defined latency time is needed here, in contrast to the solution of FIG. 2.

The actions pertaining to elements 305 to 309 may correspond fully to actions discussed in connection with elements 206 to 210 of FIG. 2, respectively, and are thus discussed here (again) for brevity. However, it should be noted that the pre-defined latency time 211 of FIG. 2 is not applicable here, as mentioned above.

In some embodiments, the TCI state update message (i.e., message 303) may be further configured to trigger use of the SRS resource set by the terminal device. In other words, the message 307 is combined into message 303. In such embodiments, the separate SRS resource set triggering message 307 may, thus, be omitted (as indicated in FIG. 3 by drawing the arrow 307 with dashed lines).

In some cases, a terminal device may be configured to implement both of the embodiments of the terminal device discussed in connection with FIGS. 2 and 3. The process of FIG. 2 may be, then, be applied, for example, for the SRS resource set(s) which are configured to follow the indicated joint downlink/uplink or uplink TCI state while the process of FIG. 3 may be applied, for example, for the SRS resource set(s) following the explicitly configured and/or activated TCI state (or spatial relation RS).

The blocks, related functions, and information exchanges described above by means of FIGS. 2 and 3 are in no absolute chronological order, and some of them may be performed simultaneously or in an order differing from the given one. In some embodiments, some of the steps may be neglected, for example, if the relevant information is already available (e.g., stored to a memory).

FIG. 4 illustrates an apparatus 401 configured to carry out the functions described above in connection with a terminal device. The apparatus 401 may be a terminal device or a part thereof (e.g., a computing device comprised in a terminal device) or an apparatus (e.g., a computing device) communicatively connected to a terminal device. The apparatus 401 may, for example, correspond to any of the terminal devices 100, 102 of FIG. 1 or a part thereof. The apparatus 401 may be an electronic device comprising electronic circuitries. The apparatus 401 may be a separate network entity or a plurality of separate entities.

The apparatus 401 may comprise a communication control circuitry 420, such as at least one processor, and at least one memory 430 including a computer program code (software) 431 wherein the at least one memory and the computer program code (software) are configured, with the at least one processor, to cause the apparatus to carry out (or cause carrying out by the terminal device) any one of the embodiments of the terminal device described above.

The memory 430 may comprise a database 432 which may comprise information on, for example, one or more capability value sets and one or more associated capability value set indices, one or more SRS resource sets (and one or more associated SRS resource set indices), one or more CSI-RSs and one or more associated CRIs, one or more SSBs and one or more associated SSSBRIs and/or one or more configured joint downlink/uplink TCI states or separate configured downlink and/or uplink TCI states.

Referring to FIG. 4, the communication control circuitry 420 may comprise uplink beam/panel selection circuitry 421. The uplink beam/panel selection circuitry 421 may be configured, for example, to carry out any of the processes performed by the terminal device in FIGS. 2 and/or 3 or in the text above.

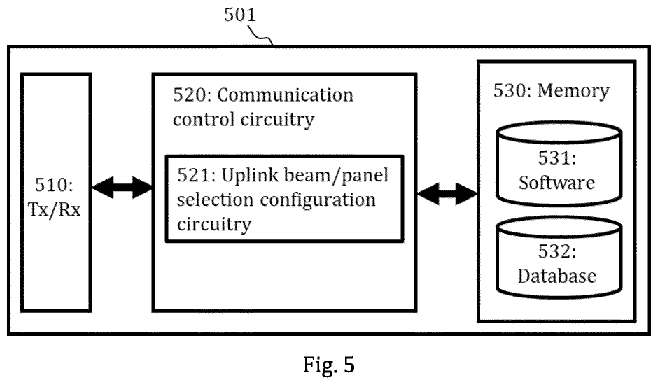

FIG. 5 illustrates an apparatus 501 configured to carry out the functions described above in connection with an access node. The apparatus 501 may be an access node or a part thereof (e.g., a computing device comprised in a terminal device) or an apparatus (e.g., a computing device) communicatively connected to a terminal device. The apparatus 501 may, for example, correspond to the access node 104 of FIG. 1 or a part thereof. The apparatus 501 may specifically be a gNB or eNB or a part thereof. The apparatus 501 may be an electronic device comprising electronic circuitries. The apparatus 501 may be a separate network entity or a plurality of separate entities.

The apparatus 501 may comprise a communication control circuitry 520 such as at least one processor, and at least one memory 530 including a computer program code (software) 531 wherein the at least one memory and the computer program code (software) are configured, with the at least one processor, to cause the apparatus to carry out (or cause carrying out by the access node) any one of the embodiments of the access node described above.

The memory 530 may comprise a database 532 which may comprise, for example, terminal device information reported to the access node by the terminal device. The terminal device information may comprise any of the information described above as being maintained in the memory of the terminal device.

Referring to FIG. 5, the communication control circuitry 520 may comprise uplink beam/panel selection configuration circuitry 521. The uplink beam/panel selection configuration circuitry 521 may be configured, for example, to carry out any of the processes performed by the access node in FIGS. 2 and/or 3 or in the text above.

The apparatuses 401, 501 described in relation to FIGS. 4 and 5 may further comprise communication interfaces (Tx/Rx) 410, 510 comprising hardware and/or software for realizing communication connectivity according to one or more communication protocols. The communication interface may provide the apparatus with communication capabilities to communicate in the cellular communication system and enable communication, for example, with network nodes and terminal devices. Specifically, the communication interfaces 410 of FIG. 4 may enable communication with one or more access nodes and the communication interfaces 510 of FIG. 5 may enable communication with one or more terminal devices and one or more core network elements. The communication interfaces 410, 510 may comprise standard well-known components such as an amplifier, filter, frequency-converter, (de)modulator, and encoder/decoder circuitries and one or more antennas. The communication interfaces 410, 510 may comprise radio interface components providing the apparatus with radio communication capability in the cell.

The memories of the apparatuses described in relation to FIGS. 4 and 5 may be implemented using any suitable data storage technology, such as semiconductor based memory devices, flash memory, magnetic memory devices and systems, optical memory devices and systems, fixed memory and removable memory.

As used in this application, the term “circuitry may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In an embodiment, at least some of the processes described in connection with FIGS. 2 and 3 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 2 and 3 or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chipset (procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

In an embodiment, there is provided an apparatus (e.g., terminal device or a part thereof or a (computing) device communicatively connected to a terminal device) comprising means for performing:
causing transmitting, by a terminal device, a first message comprising a capability value set index and at least one of a synchronization signal block resource index, SSBRI or a channel state information reference signal resource index, CRI, wherein the capability value set index is associated with a sounding reference signal, SRS, resource set configured to the terminal device;
causing the terminal device to receive a second message defining a transmission configuration indication, TCI, state comprising a quasi co-location, QCL, -TypeD reference signal corresponding to one of the at least one of the SSBRI or the CRI or being quasi co-located in terms of QCL-TypeD with a reference signal corresponding to one of the at least one of the SSBRI and the CRI;
causing the terminal device to active or indicate the TCI state according to the second message; and
if the SRS resource set is different from a currently activated SRS resource set of the terminal device or an SRS resource set last used for transmission by the terminal device, applying a pre-defined latency time between beam application and an expected triggering time of the SRS resource set.

In an embodiment, there is provided an apparatus (e.g., a terminal device or a part thereof or a (computing) device communicatively connected to a terminal device) comprising means for performing:
causing transmitting, by a terminal device, a first message comprising a capability value set index and at least one of a synchronization signal block resource index, SSBRI, or a channel state information reference signal resource index, CRI, wherein the capability value set index is associated with a sounding reference signal, SRS, resource set configured to the terminal device; and
in response to receiving a TCI state update message for the SRS resource set, causing updating of the TCI state for the SRS resource set.

In an embodiment, there is provided an apparatus (e.g., an access node or a part thereof or a (computing) device communicatively connected to an access node) comprising means for performing:
causing receiving, by an access node, a first message comprising a capability value set index and at least one of a synchronization signal block resource index, SSBRI, and a channel state information reference signal resource index, CRI, wherein the capability value set index is associated with a sounding reference signal, SRS, resource set configured to the terminal device; and
in response to the capability value set index failing to match a capability value set index last reported to the access node, causing transmitting by the access node a second message defining a transmission configuration indication, TCI, state comprising a quasi co-location, QCL, -TypeD reference signal corresponding to one of the at least one of the SSBRI and the CRI or is quasi co-located in terms of QCL-TypeD with a reference signal corresponding to one of the at least one of the SSBRI and the CRI.

In an embodiment, there is provided an apparatus (e.g., an access node or a part thereof or a (computing) device communicatively connected to an access node) comprising means for performing:
receiving, from a terminal device, a first message comprising a capability value set index and at least one of a synchronization signal block resource index, SSBRI, and a channel state information reference signal resource index, CRI, wherein the capability value set index is associated with a sounding reference signal, SRS, resource set configured to the terminal device; and
in response to the capability value set index failing to match a capability value set index last reported by the terminal device, causing transmitting, to the terminal device, a TCI state update message for the SRS resource set.

Embodiments as described above may also be carried out in the form of a computer process defined by a computer program or portions thereof. Embodiments of the methods described in connection with FIGS. 2 to 3 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising:
at least one processor; and
at least one memory including computer program code;
the at least one memory and the computer program code configured to, with the at least one processor, cause the apparatus at least to perform:
causing a terminal device to transmit, a first message comprising a capability value set index and at least one of a synchronization signal block resource index, SSBRI or a channel state information reference signal resource index, CRI, wherein the capability value set index is associated with a sounding reference signal, SRS, resource set configured to the terminal device;
causing the terminal device to receive a second message defining a transmission configuration indication, TCI, state comprising a quasi co-location, QCL-TypeD reference signal corresponding to one of the at least one of the SSBRI or the CRI or being quasi co-located in terms of QCL-TypeD with a reference signal corresponding to one of the at least one of the SSBRI or the CRI;
causing the terminal device to activate or indicate the TCI state according to the second message; and
if the SRS resource set is different from a currently activated SRS resource set of the terminal device or an SRS resource set last used for transmission by the terminal device, applying a pre-defined latency time between beam application and an expected triggering time of the SRS resource set.

2. The apparatus of claim 1, wherein the second message is a TCI state activation message or the second message is a TCI state indication message.

3. The apparatus of claim 2, wherein the at least one memory and the computer program code are configured to, with the at least one processor, further cause the apparatus to activate or indicate the TCI state by:
if the second message is the TCI state activation message, activating the TCI state being a currently non-activated TCI state configured to the terminal device; and/or
if the second message is the TCI state indication message, indicating the TCI state being a currently activated TCI state configured to the terminal device.

4. The apparatus according to claim 1, wherein the at least one memory and the computer program code are configured to, with the at least one processor, further cause the apparatus to perform:
if a TCI state update message for the SRS resource set is received, causing the terminal device to update the TCI state for the SRS resource set, wherein the pre-defined latency time is not applied following the receiving of the TCI state up-date message.

5. The apparatus of claim 4, wherein the TCI state update message is a medium access control-control element, MAC-CE, message.

6. The apparatus according to claim 4, wherein the TCI state update message is further configured to trigger use of the SRS resource set and the at least one memory and the computer program code are configured to, with the at least one processor, further cause the apparatus to trigger the use of the SRS re-source set for transmission in response to the receiving of the TCI state update message.

7. The apparatus according to claim 1, wherein the first message comprises N SSBRIs and/or N CRIs, N being 1, 2, 3 or 4.

8. The apparatus according to claim 1, wherein the at least one memory and the computer program code are configured to, with the at least one processor, further cause the apparatus to perform:
in response to detecting a beam failure recovery or a link re-establishment, setting an SRS resource set with lowest capabilities or lowest identifier as an active SRS resource set of the terminal device.

9. The apparatus according to claim 1, wherein the at least one memory and the computer program code are configured to, with the at least one processor, further cause the apparatus to perform:
in response to receiving a third message for triggering the SRS resource set, causing the terminal device to transmit one or more sounding reference signals using the SRS resource set.

10. An apparatus comprising:
at least one processor; and
at least one memory including computer program code;
the at least one memory and the computer program code configured to, with the at least one processor, cause the apparatus at least to perform:
causing an access node to receive a first message comprising a capability value set index and at least one of a synchronization signal block resource index, SSBRI, or a channel state information reference signal resource index, CRI, wherein the capability value set index is associated with a sounding reference signal, SRS, resource set; and
in response to the capability value set index failing to match a last reported capability value set index last reported, causing the access node to transmit a second message defining a transmission configuration indication, TCI, state comprising a quasi co-location, QCL-TypeD reference signal corresponding to one of the at least one of SSBRI or the CRI or being quasi co-located in terms of QCL-TypeD with a reference signal corresponding to one of the at least one of the SSBRI or the CRI.

11. The apparatus of claim 10, wherein the second message is a TCI state activation message or the second message is a TCI state indication message.

12. The apparatus of claim 11, wherein the at least one memory and the computer program code are configured to, with the at least one processor, further cause the apparatus to perform:
if a synchronization signal block, SSB, specified in the first message by the SSBRI or a channel state information reference signal, CSI-RS, specified in the first message by the CRI is not comprised in any activated TCI state but is comprised in one of configured but non-activated TCI states, causing the access node to transmit the TCI state active message for activating the one of configured but non-activated TCI states as the second message; and/or
if the SSB specified in the first message by the SSBRI or the CSI-RS specified in the first message by the CRI is not comprised in a currently indicated joint uplink/downlink or separate uplink TCI state but is comprised in one of currently activated TCI states, causing the access node to transmit the TCI state indication message for indicating one of the currently activated TCI states as the second message.

13. A method comprising:
transmitting a first message comprising a capability value set index and at least one of a synchronization signal block resource index, SSBRI or a channel state information reference signal resource index, CRI, wherein the capability value set index is associated with a sounding reference signal, SRS, resource set configured to the terminal device;
receiving a second message defining a transmission configuration indication, TCI, state comprising a quasi co-location, QCL-TypeD reference signal corresponding to one of the at least one of the SSBRI or the CRI or being quasi co-located in terms of QCL-TypeD with a reference signal corresponding to one of the at least one of the SSBRI and the CRI;
activating or indicating the TCI state according to the second message; and
if the SRS resource set is different from a currently activated SRS re-source set or an SRS resource set last used for transmission, applying a pre-defined latency time between beam application and an expected triggering time of the SRS resource set.

14. (canceled)

15. (canceled)
